(19) United States
(12) Patent Application Publication
(10) Pub. No.: US 2005/0157498 A1
(43) Pub. Date: Jul. 21, 2005

(54) Luminaire and method for repairing a luminaire

(76) Inventor: Norbert Dicken, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/504,661

(22) PCT Filed: Feb. 5, 2003
(86) PCT No.: PCT/IB03/00382

(30) Foreign Application Priority Data
Feb. 21, 2002 (EP) 02075660.7
Oct. 16, 2002 (EP) 02079273.5

(51) Int. Cl. F21V 1/00

(52) U.S. Cl. 362/277

(57) ABSTRACT

Luminaire including a base unit (9) and a diffuser unit (8). The base unit (9) comprises a housing (4) having an open front side and containing a holder for a lamp (6). The diffuser unit (8) comprises a diffuser plate (7) and side walls (17) extending from the edge of the diffuser plate (7). The diffuser unit (8) is removably fixed in the housing (4), so that the diffuser plate (7) fills up the front side of the housing (4), whereby the side walls (17) extend inside the housing (4). The luminaire furthermore comprises releasable coupling means (25,26) connecting the diffuser unit (8) and the base unit (9).

The invention is related to a luminaire including a base unit and a diffuser unit, the base unit comprising a housing having an open front side and containing a holder for a lamp, and the diffuser unit comprising a diffuser plate. The luminaire also may comprise one or more lamps, however, it can be stored and sold without lamps.

Such luminaire is provided with a flat and smooth front surface formed by the diffuser plate, whereby the light is equally distributed over that front surface. By positioning a number of such luminaires next to each other, a lightening surface can be created. For example, the lightening surface can be used as ceiling or portion of a ceiling, or as vertical wall or portion of such wall.

Especially when the front surface of the luminaire has to form a flat surface with other luminaires or with other ceiling parts or wall parts, the luminaire has to be opened at the front side for maintenance or repair. However, means for opening and closing the luminaire should not be visible at the front side of the luminaires forming a smooth ceiling surface or wall surface.

The object of the invention is to provide an improved luminaire having a flat diffuser plate substantially over its entire front side and being easy to open for repair and maintenance.

In order to accomplish that objective, the diffuser plate is provided with side walls extending from the edge of the diffuser plate, whereby the diffuser unit is removably fixed in the housing, so that the diffuser plate fills up the front side of the housing, whereby the side walls extend inside the housing, the luminaire furthermore comprising releasable coupling means connecting the diffuser unit and the base unit.

Preferably the diffuser plate is of plastic material and covers the entire front side of the luminaire. Because of the side walls are attached to the edge of the diffuser plate, a rigid diffuser unit is achieved. The diffuser unit can be taken out of the base unit by attaching suction cups against the diffuser plate and pulling the diffuser unit through the suction cups, whereby the coupling means release the diffuser unit.

Preferably the housing contains one or more tube-like fluorescent lamps, preferably low-pressure mercury discharge lamps. More preferably the housing contains a number of straight tube-like fluorescent lamps being positioned parallel with respect to each other. A good distribution of the lamps over the area of the luminaire is advantageous.

In one preferred embodiment the diffuser unit furthermore comprises a light curtain plate being positioned substantially parallel to the diffuser plate and being connected to the diffuser plate through said side walls. Thereby the diffuser unit is further reinforced. The light curtain plate is preferably made of plastic material and may have a varying transparency over its surface, to distribute the light more equally towards the diffuser plate.

Preferably, the diffuser plate, the side walls and the light curtain plate form a closed light box, preferably a dust-tight box light box. Dust particles and flies and the like at the back side of the diffuser plate can be seen at the front side of the diffuser plate as dark dots. Therefore it is an advantage to keep the back side of the diffuser plate free from dust and the like. Furthermore the closed light box forms a very rigid portion of the diffuser unit, so that the diffuser unit—even when it has large dimensions—can be easily handled. The diffuser plate may have a dimension of a square with a side of 1.2 meter.

In one preferred embodiment the light curtain plate has an undulated shape, whereby near the lamp the distance between the flat diffuser plate and the undulated light curtain plate is smaller than further away from the lamp. Such shape of the light curtain plate appeared to improve the equal distribution of the light over the surface of the diffuser plate.

In one preferred embodiment the light curtain plate has a varying thickness, the thickness being relative great near the lamp. Also such shape of the light curtain plate appeared to improve the equal distribution of the light over the surface of the diffuser plate.

Preferably, the distance between the light curtain plate and the lamp positioned closest to the light curtain plate is between one and two times the diameter of the tube of the lamp.

In one preferred embodiment the diffuser unit furthermore comprises walls having a light reflecting surface reflecting the light from the lamps towards the light box. By making these walls part of the diffuser unit, also these walls will be removed from the housing when, for example, the lamps has to be replaced. Thereby the reflecting surface will not be touched by hands of the operating personnel.

Preferably, the coupling means comprise resilient clamps, so that the diffuser unit can be pulled out of the base unit and be pushed into the base unit to return it in its operating position. Thereby any portion of the coupling means outside the luminaire is avoided.

In one preferred embodiment the diffuser unit is connected to the base unit by two or more, preferably four, wires, preferably steel wires, so that the diffuser unit suspends by the wires at a distance from the base unit after the diffuser unit is pulled out of the base unit. Preferably, spring means tighten each of the wires, so that the weight of the diffuser unit is at least partly compensated. Because of the spring means the wires are stored in a correct way inside the housing when the luminaire is assembled.

The invention is also related to a method for repairing a luminaire including a base unit and a diffuser unit, the base unit comprising a housing having an open front side and containing a lamp, and the diffuser unit comprising a diffuser plate and side walls extending from the edge of the diffuser plate, whereby the diffuser unit is removed from the housing by placing suction cups against the diffuser plate and pulling the diffuser unit out of the base unit by means of the suction cups.

The invention will be further explained hereinafter by means of a description of an embodiment of a luminaire, in which reference is made to a drawing, in which:

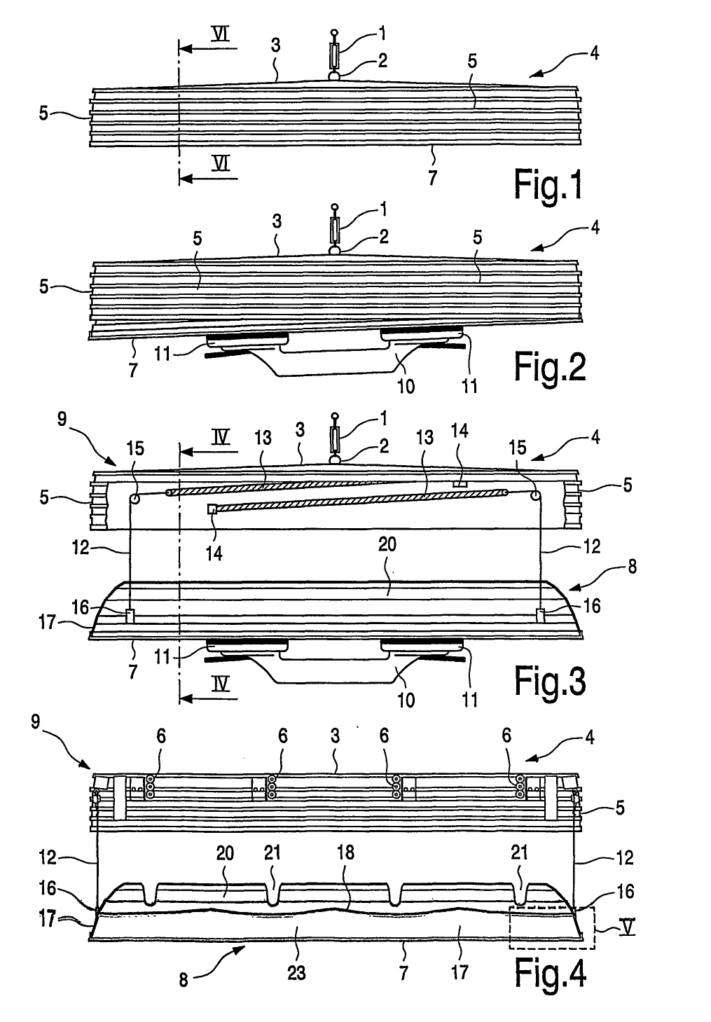

FIG. 1 is a side view of a luminaire;

FIG. 2 shows how to open the luminaire;

FIG. 3 shows an opened luminaire;

FIG. 4 is a sectional view along the line IV-IV in FIG. 3;

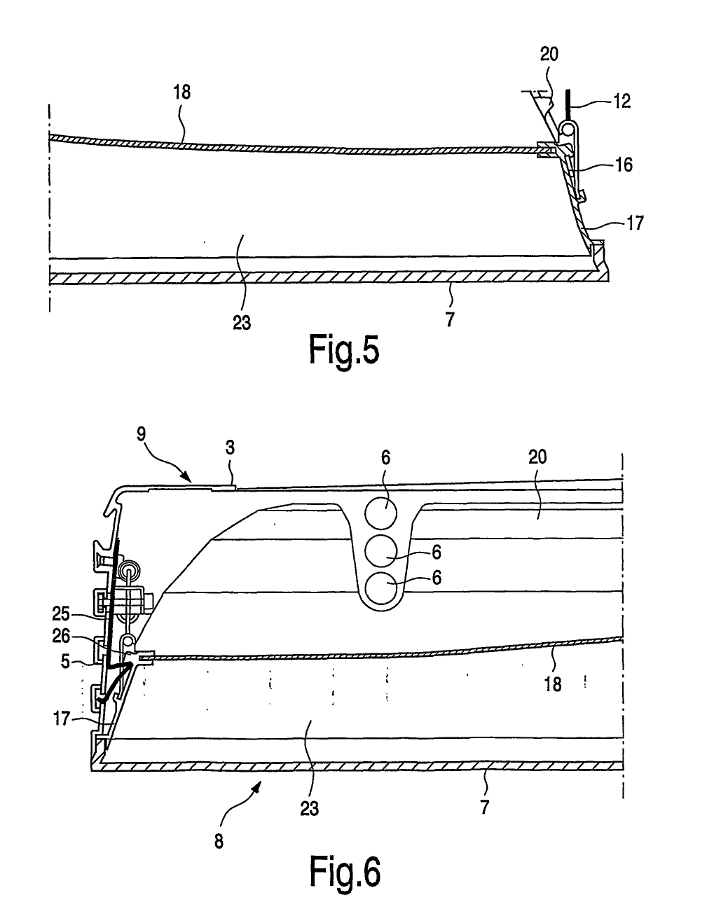

FIG. 5 shows the portion indicated by the dotted line V in FIG. 4 in more detail; and

FIG. 6 is a part of the sectional view along the line VI-VI in FIG. 1.

The Figures are merely schematic representations of the embodiment, in which less relevant parts are not shown.

FIG. 1 shows a luminaire suspending by means of a suspension member 1. The suspension member 1 is attached to the luminaire through a connecting element 2 in the center of the upper wall 3 of the housing 4 of the luminaire.

The side walls 5 of the aluminum housing 4 of the luminaire are provided with a profile forming horizontal grooves. The housing 4 comprises one or more lamps 6 (see FIG. 4) and forms—together with the lamps 6—the base unit 9 of the luminaire. FIG. 1 shows the base unit 9 with inside the diffuser unit 8 comprising a diffuser plate 7. Diffuser plate 7 forms the front side of the luminaire.

FIG. 2 shows the removal of the diffuser unit 8 from the housing 4. A device 10 provided with a number of suction cups 11 is attached to the diffuser plate 7 after which the diffuser plate 7, and therewith the diffuser unit 8, can be pulled downwardly out of the housing 4, whereby resilient clamps 25 (see FIG. 6) in the housing 4 release the diffuser unit 8.

FIG. 3 shows the diffuser unit 8 suspending underneath the base unit 9 through four steel wires 12, whereby a portion of the side wall 5 of the housing 4 is left out to show the steel wires 12 and the helical steel springs 13 tensioning the wires 12. The steel wires 12 are spring loaded, so that the weight of the diffuser unit 8 is partly compensated facilitating the handling of the diffuser unit 8.

Each helical spring 13 is attached to the housing 4 through fixation plate 14. Each helical spring 13 is at its other end attached to the steel wire 12. Steel wire 12 is engaging pulley 15 and at its end attached to diffuser unit 8 through fixation plate 16.

FIG. 4 is a sectional view of the diffuser unit 8 suspending underneath the base unit 9. In the housing 4, four groups of three tube-like fluorescent lamps 6 are present. Each group includes three lamps above each other, which lamps may have different colors. Therefore the color of the light from the luminaire can be varied by reducing the radiation from one or two lamps 6 of the group of three lamps 6.

The lampholders of the lamps 6 are mounted in the housing 4 of the luminaire, so that the lamps 6 stay in the housing 4 when the diffuser unit 8 is removed. The housing 4 and lamps 6 and other related parts form the base unit 9 of the luminaire.

The diffuser unit 8 comprises a dust-tight light box 23 (see FIG. 5) composed by the diffuser plate 7, side walls 17 extending from the edge of the diffuser plate 7 and a light curtain plate 18 being positioned substantially parallel to the diffuser plate 7 and being connected to the diffuser plate 7 through said side walls 17.

The light curtain plate 18 may have a varying transparency. Furthermore, the light curtain plate 18 is not flat, but curved around the lamps 6, so that the distance between the diffuser plate 7 and the light curtain plate 18 is smaller near the lamps 6 then at more distance from the lamps 6.

The diffuser unit 8 furthermore comprises a wall 20 provided with a light reflecting surface. The wall 20 have recesses 21 for accommodating the lamps 6 when the luminaire 1 is assembled. Thereby the lamps 6 are surrounded by the light curtain plate 18 and the wall 20, except for the area above the lamps. The reflecting surface directs the radiation from the lamps 6 towards the light curtain plate 18.

FIG. 5 shows a portion of FIG. 4 in more detail, the portion being a part of the light box 23 in sectional view. The diffuser plate 7 is of plastic material and welded to the side wall 17, also of plastic material. Side wall 17 is welded to the light curtain plate 18, which plate is also of plastic material. Thereby a dust-tight light box 23 is created.

FIG. 6 is a part of a sectional view along the line VI-VI in FIG. 1. Diffuser unit 8 is located inside the base unit 9 and is fixed in its operational position by steel spring 25. Steel spring 25 is attached to the side wall 5 of housing 4 and engages a rib 26 of the side wall 17 of the light box 23. Because the steel spring 25 is resilient it will deform sufficiently to release the diffuser unit 8 when the diffuser unit is pulled downwardly. And when the diffuser unit 8 is moved into the base unit 9, the steel spring 25 will engage with the rib 26, so that a sufficient strong fixation of the diffuser unit 8 in the base unit 9 is achieved. There are four or more such steel springs 25 inside the housing 4 to ensure a good fixation of the diffuser unit 8 inside the base unit 9.

The embodiment of the luminaires as described above is merely an example; a great many other embodiments are possible.

1. Luminaire including a base unit and a diffuser unit, the base unit comprising a housing having an open front side and containing a holder for a lamp, and the diffuser unit comprising a diffuser plate and side walls extending from the edge of the diffuser plate, whereby the diffuser unit is removably fixed in the housing, so that the diffuser plate fills up the front side of the housing, whereby the side walls extend inside the housing, the luminaire furthermore comprising releasable coupling means connecting the diffuser unit and the base unit.

2. Luminaire as claimed in claim 1, characterized in that the housing contains one or lamps, preferably tube-like fluorescent lamps, more preferably low-pressure mercury discharge lamps.

3. Luminaire as claimed in claim 1, characterized in that the housing contains a number of straight tube-like fluorescent lamps being positioned parallel with respect to each other.

4. Luminaire as claimed in claim 1, characterized in that the diffuser unit furthermore comprises a light curtain plate being positioned substantially parallel to the diffuser plate and being connected to the diffuser plate through said side walls.

5. Luminaire as claimed in claim 4, characterized in that the diffuser plate, the side walls and the light curtain plate form a closed light box, preferably a dust-tight box light box.

6. Luminaire as claimed in claim 4, characterized in that the light curtain plate has an undulated shape, whereby near the lamp the distance between the flat diffuser plate and the undulated light curtain plate is smaller than further away from the lamp.

7. Luminaire as claimed in claim 4, characterized in that the light curtain plate has a varying thickness, the thickness being relative great near the lamp.

8. Luminaire as claimed in claim 4, characterized in that the distance between the light curtain plate and the lamp positioned closest to the light curtain plate is between one and two times the diameter of the tube of the lamp.

9. Luminaire as claimed in claim 1, characterized in that the diffuser unit furthermore comprises walls having a light reflecting surface reflecting the light from the lamps towards the diffuser plate.

10. Luminaire as claimed in claim 1, characterized in that the coupling means comprise resilient clamps, so that the diffuser unit can be pulled out of the base unit and be pushed into the base unit to return it in its operating position.

11. Luminaire as claimed in claim 1, characterized in that the diffuser unit is connected to the base unit by two or more, preferably four, wires, preferably steel wires, so that the diffuser unit suspends by the wires at a distance from the base unit after the diffuser unit is pulled out of the base unit.

12. Luminaire as claimed in claim 11, characterized by spring means for tightening each of the wires.

13. Method for repairing a luminaire including a base unit and a diffuser unit, the base unit comprising a housing having an open front side and containing a lamp, and the diffuser unit comprising a diffuser plate and side walls extending from the edge of the diffuser plate, characterized in that the diffuser unit is removed from the housing by placing suction cups against the diffuser plate and pulling the diffuser unit out of the base unit by means of the suction cups.

14. Method as claimed in claim 13, characterized in that the diffuser unit remains connected to the base unit by two or more wires, whereby the diffuser unit suspends by the wires at a distance from the base unit.
